(19) United States
(12) Patent Application Publication
(10) Pub. No.: US 2014/0030565 A1
(43) Pub. Date: Jan. 30, 2014

(54) BATTERY PACK FOR VEHICLE

(71) Applicants: HYUNDAI MOTOR COMPANY, Seoul (KR); KIA MOTORS CORPORATION, Seoul (KR)

(72) Inventors: Hae Kyu Lim, Bucheon (KR); Yoon Cheol Jeon, Suwon (KR)

(73) Assignees: Kia Motors Corporation, Seoul (KR); Hyundai Motor Company, Seoul (KR)

(21) Appl. No.: 13/688,086

(22) Filed: Nov. 28, 2012

(30) Foreign Application Priority Data
Jul. 30, 2012 (KR) 10-2012-0082881

(51) Int. Cl. H01M 10/50

(52) U.S. Cl. CPC H01M 10/5016
USPC 429/82

(57) ABSTRACT

Disclosed is a battery pack for a vehicle, including: a case configured to receive a battery. The case includes a recessed lower surface forming an air passage to allow air to flow from one side of a lower surface of the case to another side to cool the battery there above. A passage guide is formed by a cover coupled to a side surface of the case to form an air duct. The air duct extends at least from an upper end side to a lower end side of the case and a lower end of the air duct is connected to an inlet portion of the air passage formed on a lower surface of the case.

### CROSS-REFERENCE TO RELATED APPLICATION

This application claims under 35 U.S.C. §119(a) the benefit of Korean Patent Application No. 10-2012-0082881 filed on Jul. 30, 2012, the entire contents of which are incorporated herein by reference.

### BACKGROUND

(a) Technical Field

The present invention relates to an integrated battery pack in which a duct through which air is introduced and a battery case are integrated to provide an air passage while at the same time sealing and waterproofing the integrated battery pack.

(b) Background Art

Recently environmentally-friendly vehicles have started to become highly desirable by consumers due to an increased amount of carbon dioxide within the atmosphere and the rising cost of oil. As a result, manufactures have begun mass-production of these environmentally friendly vehicles. Environmentally friendly vehicles may include hybrid vehicles using electricity as a driving source, electric motor vehicles, plug-in vehicles, and/or fuel cell vehicles.

Vehicles with an electric motor require a battery or other electrical source to be mounted within the vehicle. These batteries are typically installed in floor panel or tire wells of the vehicles. Such a battery needs to be able to cool heat generated by the battery while the vehicle is being driven, and thus also requires a cooling duct through which air for cooling the battery flows therethrough.

Additionally, a battery and a high-voltage part are typically mounted to an interior of an existing tire well and a case is applied to an interior of the tire well to waterproof the battery and high voltage part. However, this case is applied only prevents water from getting into the case and does not provide a cooling duct is additionally necessary such that introduced air can flow therethrough to cool a battery. Accordingly, the weight of battery pack, the material costs, and the manufacturing costs are all increased due to an increase of the number of parts necessary to assembly the battery pack.

The items described as the background art is provided just to help understanding of the background of the present invention, and shall not be construed to admit that they correspond to the technologies already known to those skilled in the art to which the present invention pertains.

### SUMMARY OF THE DISCLOSURE

An object of the present invention is to provide an integrated battery pack in which a waterproof case and an air passage for cooling the battery are integrated into the battery pack as a single part. In one aspect, the present invention provides a battery pack for a vehicle, including:

a case configured to receive a battery, the case including a lower recessed surface forming an air passage to allow air to flow from one side of a lower surface of the case to another side to cool the battery there above; and a passage guide formed by a cover coupled to a side surface of the case to form an air duct together with the case, in which the air duct extends from an upper end side to a lower end side of the case and a lower end of the air duct is connected to an inlet of the air passage formed on a lower surface of the case so that air introduced from an upper end of the case is introduced into the air passage formed on a lower surface of the case through the air duct.

In some embodiments, a space between the battery received in the case and a lower surface of the case may be sealed so that introduced air is prevented from being leaked to the outside. Additionally, a portion of the case facing the passage guide may be bent to protrude to the outside, so that a flow amount of air passing through the passage guide is increased.

An upper end of the passage guide may be bent to extend in a direction in which air is introduced and a lower end thereof may be bent to extend in a direction of the air passage formed on a lower surface of the case so that air flows smoothly therethrough. Additionally, extending portions of the upper end and lower end of the passage guide may also be bent to be curved so that air flows smoothly therethrough.

Furthermore, the passage guide may be coupled to opposite side surfaces of the case and a lower end of the passage guide may be connected to a starting portion and an ending portion of the air passage formed on a lower surface of the case so that a passage is formed from the inlet to an outlet of air. Also, the passage guide and the case may be formed in female and male shapes, respectively, at a coupling portion thereof to be coupled to each other to increase the coupling force therebetween.

In a still further embodiment, a flange may be formed lengthwise in the passage guide at a peripheral portion contacting the case and the flange may be bonded to the case to increase the coupling force. The flange of the passage guide and the case may be fused to each other, and/or may be formed in female and male shapes, respectively, at a coupling portion thereof to be coupled and fused so that the passage guide is fixed to the case.

In the above-configured battery pack for a vehicle, a lower surface of a case is recessed to form an air passage through which air flows, and the air guide is formed in a cover coupled to a side surface of the case so as to form an air duct. The air duct is connected to the air passage to introduce the air introduced from an upper end of the case into the air passage, making it possible to cool the battery via the same structure which provides the waterproofing function. Through the structure, the number of parts constituting the battery pack is reduced, making it possible to reduce a weight, material costs, and manufacturing costs of the battery pack.

Further, a portion of the case facing the passage guide is bent to protrude to the outside, and therefore of the flow rate of air passing through the passage guide can be increased. Additionally, an upper end and a lower end of the passage guide are bent to extend in an air introducing direction and an air passage direction, and the extending portion is formed to be curved so that air can flow smoothly therethrough. A flange may also be formed in the passage guide and portions of the passage guide and the case corresponding to each other may be formed in female or male shapes to be coupled to each other, thereby increasing the coupling force therebetween and therefore the case's waterproofing ability.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a perspective view of a battery pack for a vehicle according to the first exemplary embodiment of the present invention;

FIG. 2 is a perspective view of a battery pack for a vehicle according to the second exemplary embodiment of the present invention; and

FIG. 3 is a view showing a shape of a bonding surface of a case and a passage guide of the battery pack for a vehicle shown in FIG. 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a battery pack for a vehicle according to an exemplary embodiment of the present invention will be described with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

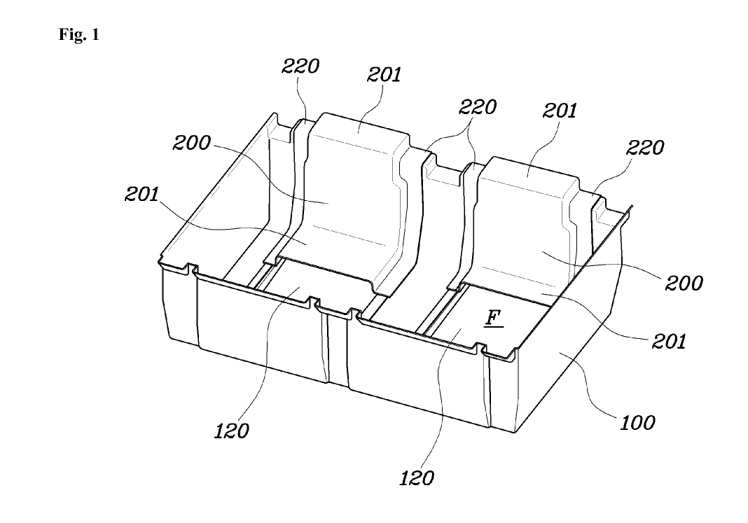

FIG. 1 is a perspective view of a battery pack for a vehicle according to the first embodiment of the vehicle, and the present invention includes a case 100 provided, for example, in a tire well of the vehicle, to receive a battery and having a lower surface which is recessed so that air for cooling a battery flows from one side to another side and in which an air passage 120 is formed. A passage guide (or air flow duct) 200 formed by a cover coupled to a side surface of the case 100, in which the air duct extends from an upper end side to a lower end side of the case 100 and a lower end of the air duct of the case is connected to an inlet of the air passage formed on the lower surface of the case 100 so that air introduced from an upper end of the case 100 is introduced into the air passage 120 formed on a lower surface of the case 100 through the air duct.

In general, when a battery of a vehicle is provided in a tire well, a battery needs to be provided on a lower side of a floor panel of the vehicle to introduce air for cooling the battery from an upper side of a case 100. Thus, a cooling duct functioning as an air passage typically needs to be separately installed to circulate the air introduced from the upper side of the case 100 to the battery in the conventional art. Further, when a battery retains moisture, the performance of the battery deteriorates which can result in the vehicle breaking down or worse, an accident, and thus a case 100 having a sealing effect to prevent the battery from contacting moisture needs to be applied as well.

However, in the present invention, as an air passage 120 is formed to be recessed from one side to another side of the case so that air introduced to cool a battery may flow over a lower surface of the case 100, introduced air can be guided to the battery to be cooled without using a separate cooling duct while at the same time maintaining it case's require waterproofing function.

Further, the passage guide 200 may be formed by a cover coupled to a side surface of the case 100 to form an air duct together with the case. The air duct may be formed to extend from an upper end side to a lower end side of the case 100 so that the air introduced from an upper end of the case 100 may be introduced into the air passage 120 formed on a lower surface of the case 100. That is, the air duct formed when the passage guide 200 and the case 100 are coupled to each other forms an air duct through which the introduced air flows therethrough, and thus the introduced air can be introduced into the case where the battery is disposed without using a separate cooling duct.

Thus, the present invention eliminates the need for separate cooling duct by recessing a lower interior surface of the case to form an air passage for cooling a battery, and by forming a passage guide 200 having a cover and a side surface of the case coupled to each other to form an air duct through which air can flow. This can reduces the total number of parts that are required to assembly a battery pack. Accordingly, a weight, material costs, and manufacturing costs of a battery pack can be significantly reduced.

Meanwhile, a space between the battery received in the case 100 and the air passage 120 formed on a lower surface of the case is sealed so that introduced air is prevented from being leaked to the outside. In the present invention, a sealing pad is provided between the battery and the air passage 120. Additionally, the battery provided on an upper side of the air passage 120 presses against the sealing pad so that the cooling air introduced into the air passage 120 formed on a lower surface of the case is prevented from being leaked to the outside. A portion, of the case 100 facing the passage guide 200 may be bent to protrude to the outside to increase the air flow rather through the passage guide 200.

In general, the amount of introduced air for cooling the battery needs to be increased to quickly cool the battery. In this case, a flow rate and an amount of air introduced into the battery may be increased by increasing the drive force/speed of a battery cooling fan installed in the battery. Further, although an amount of introduced air may be increased by increasing an area of the air duct to increase a cooling efficiency of the battery, a battery receiving space in the case 100 may be decreased when an area of a passage for air is increased to increase an amount of introduced air.

In the present invention, a passage guide 200 may be formed from a cover coupled to a side surface of the case 100 to form an air duct together with the case 100, such that air flows through the air duct to be introduced into the air passage 120 provided on a lower surface of the case 100. In this case, the air duct needs to be widened to increase an amount of air introduced into the air passage 120. Thus, a portion of the case 100 facing the passage guide 200 is bent to protrude to the outside, and thus the space into which the battery is received can be secured in the case and an air duct through which air flows can be widened, making it possible to increase the air flow rate therethrough.

As can be seen in FIG. 1, an upper end of the passage guide 200 is bent to extend in a direction in which air is introduced, and a lower end thereof may be bent to extend in a direction of the air passage 120 formed on a lower surface of the case 100. Further, extending portions of the upper end and lower end of the passage guide 200 may also be bent to be curved so that air is smoothly flowed.

When the battery is received in the tire well of the vehicle, the air for cooling the battery is introduced from an upper side of the case 100, and thus the introduced air needs to be guided to the air passage 120 provided on the lower side. Thus, an upper end of the passage guide 200 is bent to extend in a direction in which air is introduced, and thus the air introduced from the outside of the case 100 is guided to flow into the case 100. A lower end of the passage guide 200 is bent to extend in a direction of the air passage 120 formed on a lower surface of the case 100, and thus the air introduced into the case 100 can be guided to the air passage 120 formed on a lower surface of the case so that the introduced air can cool the battery.

Here, if the extending portions of the upper end and lower end of the passage guide 200 linear in shape so that the air flowing therethrough reaches a 90 degree angle, the introduced air may collide with the extending portion of the passage guide 200, causing resistance and serving as an obstruction against resistance free air flow. Thus, the extending portions of the upper end and lower end of the passage guide 200 are bent to be curved, and thus a resistance caused during air flow is minimized and the air introduced from the upper side of the case 100 can smoothly flow to the lower side.

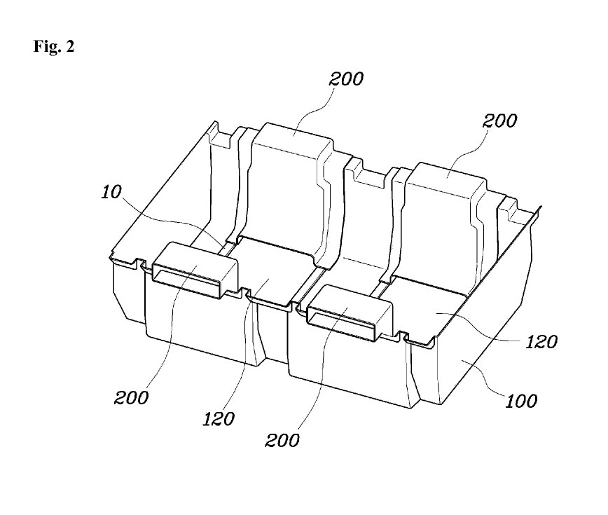

FIG. 2 is a perspective view of a battery pack for a vehicle according to the second embodiment of the present invention, and the passage guide 200 is coupled to opposite side surfaces of the case 100 and a lower end of the passage guide 200 is connected to an inlet portion and an outlet portion of the air passage 120 formed on a lower surface of the case 100 so that a passage is formed between an inlet and an outlet.

In general, after air introduced to cool a battery cools a battery, a temperature thereof increases, and the air whose temperature has increased is discharged again to be recirculated to cool the battery. That is, a discharge duct for discharging air whose temperature has been increased after the air introduced from the upper side of the case is introduced into the air passage 120 fog, led on a lower surface of the case to cool the battery should be provided, and if the discharge duct is additionally provided in the case 100, a weight, material costs and manufacturing costs of the battery pack increase.

Thus, the same structure as that of the passage guide 200 is applied to the discharge duct for discharging whose temperature has been increased after the discharge duct cools the battery and the passage guide 200 is coupled to opposite side surfaces of the case 100, and a lower end of the passage guide 200 is connected to an inlet portion and an outlet portion of the air passage 120 formed on a lower surface of the case 100 so that a passage is formed between an inlet to an outlet of air. Thus, a battery pack in which a passage is formed in the case 100 from an inlet to an outlet of air and which cools a battery while reducing a weight, material costs, and manufacturing costs thereof.

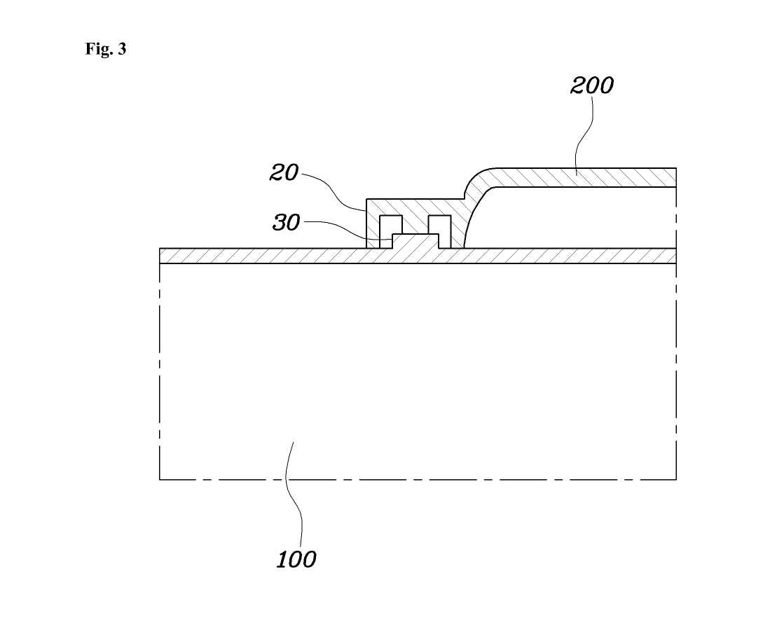

FIG. 3 is a view showing a shape of a bonding surface of the case 100 and the passage guide 200 of the battery pack shown in FIG. 1 wherein the passage guide 200 and the case 100 are formed in female and male shapes 20, 30 respectively, at a coupling portion thereof to be coupled to each other to increase coupling force.

The present invention also should be sealed so that introduced air is not leaked to the outside after the case 100 and the passage guide 200 are coupled to each other, in which case when the case 100 and the passage guide 100 are simply coupled to each other, a manufacturing error may occur or the coupling force may be insufficient, causing introduced air to be leaked. Thus, the passage guide 200 and the case 100 may be formed in female and male shapes 20, 30 at a coupling portion to be coupled to each other, and thus a coupling force of the passage guide 200 and the case 100 may be increased and a sealing state thereof can be maintained.

Meanwhile, a flange 220 is formed lengthwise in the passage guide at a peripheral portion contacting the case 100 and the flange 220 is bonded to the case 100 to increase coupling force. In this way, if the flange 220 is formed in the passage guide 200, an area of the passage guide 200 contacting the case 100 increases, and thus the coupling force of the passage guide 200 and the case 100 can be increased as well. Here, the lengthwise direction where the flange 220 is formed refers to the flange 220 is formed based on a height of the case 100, and it is preferable to form the flange 220 from an upper end to a lower end of the passage guide 220 to increase a coupling force of the passage guide 200 and the case 100. When the passage guide 200 and the case 100 are coupled to each other, the flange 220 of the passage guide 200 and the case 100 may be fused together.

Further, the flange 220 of the passage guide 200 and the case 100 may be formed in female and male shapes, respectively, at a coupling portion thereof to be coupled and fused so that the passage guide 200 is firmly fixed to the case 100. In this way, the flange 220 may be foamed in the passage guide 200 and the case 100 may be coupled to each other to have female and male shapes 20, 30 at a coupling portion thereof, and thus an area of the passage guide 200 at the coupling portion increases, and the flange 220 of the passage guide 200 and the case 100 are coupled to each other to have female and male shapes 20, and thus a coupling force and a waterproof effect between the passage guide 200 and the case 100 can be significantly increased.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A battery pack for a vehicle, comprising:
a case configured to receive a battery, the case including a lower recessed surface forming an air passage to allow air to flow from one side of a lower surface of the case to another side to cool the battery there above; and
a passage guide formed by a cover coupled to a side surface of the case to form an air duct, in which the air duct extends from an upper end side to a lower end side of the case and a lower end of the air duct is connected to an inlet portion of the recessed air passage formed on a lower surface of the case so that air introduced from an upper end of the case is introduced into the air passage formed on a lower surface of the case through the air duct.

2. The battery pack of claim 1, wherein a space between the battery and the lower surface of the case is sealed so that introduced air is prevented from being leaked outside the case.

3. The battery pack of claim 1, wherein a portion of the case facing the passage guide is bent to protrude outside the case, so that a flow rate of air passing through the passage guide is increased.

4. The battery pack of claim 1, wherein an upper end of the passage guide is bent to extend in a direction in which air is introduced into the passage guide and a lower end thereof is bent to extend in a direction of the air passage formed on the lower surface of the case.

5. The battery pack of claim 4, wherein extending portions of the upper end and lower end of the passage guide are curved.

6. The battery rack of claim 1, wherein the passage guide is coupled to opposite side surfaces of the case and a lower end of the passage guide is connected to an inlet portion and an outlet portion of the air passage formed on the lower surface of the case so that an air passage is formed between the inlet and the outlet of the air duct.

7. The battery pack of claim 1, wherein the passage guide and the case are formed in female and male shapes, respectively, at a coupling portion thereof to be coupled to each other to increase coupling force therebetween.

8. The battery pack of claim 1, wherein a flange is formed lengthwise in the passage guide at a peripheral portion in contact with the case and the flange is bonded to the case to increase coupling force.

9. The battery pack of claim 8, wherein the flange of the passage guide and the case are fused to each other.

10. The battery pack of claim 9, wherein the flange of the passage guide and the case are formed in female and male shapes, respectively, at a coupling portion thereof to be coupled and fused so that the passage guide is fixed to the case.
